(19) United States
(12) Patent Application Publication
(10) Pub. No.: US 2026/0222962 A1
(43) Pub. Date: Jul. 30, 2026

(54) NETWORK SHARING ARCHITECTURES FOR NON-3GPP ACCESS

(71) Applicant: CABLE TELEVISION LABORATORIES, INC, Louisville, CO (US)

(72) Inventors: Omkar SHRIPAD DHARMADHIKARI, Denver, CO (US); Rahil GANDOTRA, Boulder, CO (US)

(73) Assignee: CABLE TELEVISION LABORATORIES, INC, Louisville, CO (US)

(21) Appl. No.: 19/466,029

(22) Filed: Jan. 30, 2026

Related U.S. Application Data
(60) Provisional application No. 63/751,698, filed on Jan. 30, 2025.

(51) Int. Cl. H04W 40/02; H04W 88/10

(52) U.S. Cl. CPC H04W 40/02; H04W 88/10

(57) ABSTRACT

Systems, methods, and apparatuses for network sharing architectures are provided herein. Proposed architectures extend 3GPP sharing beyond NR to non‑3GPP access (notably Wi‑Fi) by a MOCN-like model where a shared Wi‑Fi/TNAN advertises multiple PLMNs and a multi-tenant interworking edge (N3IWF/TNGF‑like) simultaneously anchors N2/N3-style connectivity to multiple operator cores, preserving separate subscriber/control domains; and an INS-like model where partner traffic is routed via the host operator’s controlled core and core‑to‑core interconnects, enabling trusted Wi‑Fi, single-step SIM/EAP authentication, predictable latency, and enforceable end‑to‑end QoS. These enable new MSO/MVNO and reciprocal cross‑RAT sharing deployments (e.g., host shares both NR+Wi‑Fi; two operators cross-share their best RATs), yielding broader coverage, seamless multi‑access mobility, resilience, faster rollout, service differentiation, and new bundles. Novelty: explicit multi-core IWF procedures, PLMN signaling in Wi‑Fi, and managed INS transit replacing “internet-to-N3IWF” untrusted assumptions.

### CROSS REFERENCE TO RELATED APPLICATIONS

This application claims the benefit of US 63/751,698 filed on January 30, 2025, which is incorporated by reference as if fully set forth.

### BACKGROUND

Standardized network sharing first emerged in the 3G era with sharing configurations in which only the radio access network is shared while each participating operator continues to operate its own separate core network. However, there is a need to address sharing paradigms outside of 3GPP access.

### SUMMARY

In one or more embodiments of the present disclosure, an apparatus is provided. Proposed architectures extend 3GPP sharing beyond NR to non‑3GPP access (notably Wi‑Fi) by a MOCN-like model where a shared Wi‑Fi/TNAN advertises multiple PLMNs and a multi-tenant interworking edge (N3IWF/TNGF‑like) simultaneously anchors N2/N3-style connectivity to multiple operator cores, preserving separate subscriber/control domains; and an INS-like model where partner traffic is routed via the host operator’s controlled core and core‑to‑core interconnects, enabling trusted Wi‑Fi, single-step SIM/EAP authentication, predictable latency, and enforceable end‑to‑end QoS. These enable new MSO/MVNO and reciprocal cross‑RAT sharing deployments (e.g., host shares both NR+Wi‑Fi; two operators cross-share their best RATs), yielding broader coverage, seamless multi‑access mobility, resilience, faster rollout, service differentiation, and new bundles. Novelty: explicit multi-core IWF procedures, PLMN signaling in Wi‑Fi, and managed INS transit replacing “internet-to-N3IWF” untrusted assumptions.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and 5G core (5GC);

FIG. 4 illustrates an example of a protocol stack for a user plane and a control plane;

FIG. 5A illustrates an example of Multi-Operator Core Network;

FIG. 5B illustrates an example of Indirect Network Sharing;

FIG. 6 illustrates an example of MOCN for non-3GPP access;

FIG. 7A illustrates an example of MOCN for non-3GPP access with shared interworking;

FIG. 7B illustrates an example of INS for non-3GPP access;

FIG. 8 illustrates an example of INS for non-3GPP access and 3GPP access;

FIG. 9 illustrates an example of INS with different host operators for non-3GPP access and 3GPP access; and

FIG. 10 illustrates an example process/system of a UE connecting to a home Operator’s network through a host Operator.

### DETAILED DESCRIPTION OF THE PREFERRED EMBODIMENTS

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

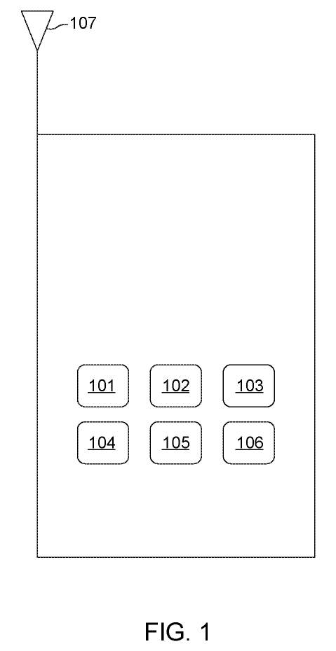

FIG. 1 is an illustration of an example device. In one case, the device may be a User Equipment (UE) suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission and demodulate signals for reception. The UE may be capable of full duplex operation, where there is transmission and reception of some or all signals may be concurrent and/or simultaneous (e.g., different timing/spacing for UL or DL).

Different radio access technologies may be used with one or more transceivers (e.g., 802.11, WCDMA, CDMA2000, GSM, LTE, LTE-A, LTE-A Pro, NR, etc.)

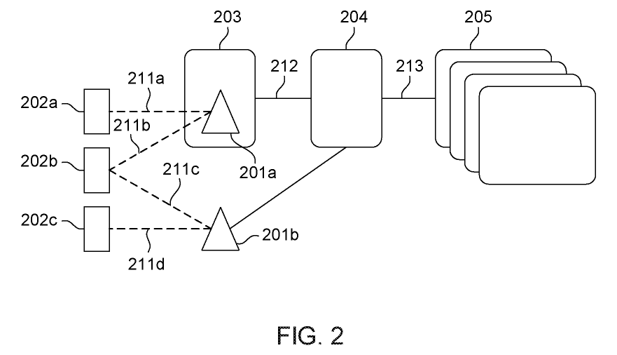

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

Generally, a communication system may use a combination of wired and wireless connections at different points in the system. One or more wireless technologies may (e.g., channel access methods), include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a,201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that use more than one type of base station (e.g., an eNB and a gNB).

In one case, the communication system may include a radio access network (RAN) 203, a core network 206, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same RAT as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMF, one or more UPF, one or more Session Management Function (SMF), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

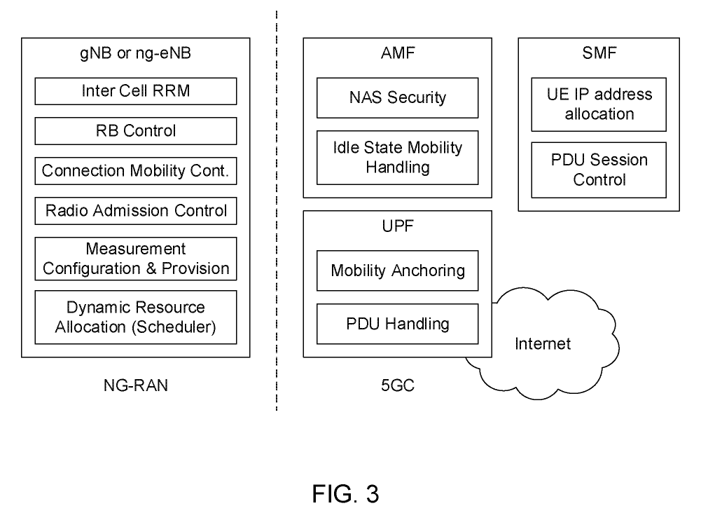

FIG. 3 illustrates an example of a functional split between the NG-RAN and 5GC. The AMF may be connected to one or more gNBs of the RAN via an N2 interface and may serve as a control node. For example, the AMF may be responsible for authenticating a UE’s support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

Generally, in a 5G RAN, there may be several interfaces that connect the UE, radio units, and the 5G Core to ensure proper control and data flow. The Uu interface is the 5G New Radio (NR) air interface between the UE and the gNB, enabling over-the-air transmission of control signaling and user data. Within the gNB, the F1 interface is used between the Central Unit (CU) and the Distributed Unit (DU); it is split into F1-C for control-plane signaling and F1-U for user-plane data transfer. When the CU itself is disaggregated, the E1 interface connects the CU-Control Plane (CU-CP) and the CU-User Plane (CU-UP), allowing independent scaling and deployment of control and user functions. Toward the 5G Core, the N2 interface links the gNB to the AMF, carrying control-plane signaling related to registration, mobility, and session management, while the N3 interface connects the gNB to the UPF and transports user-plane traffic between the RAN and the core network.

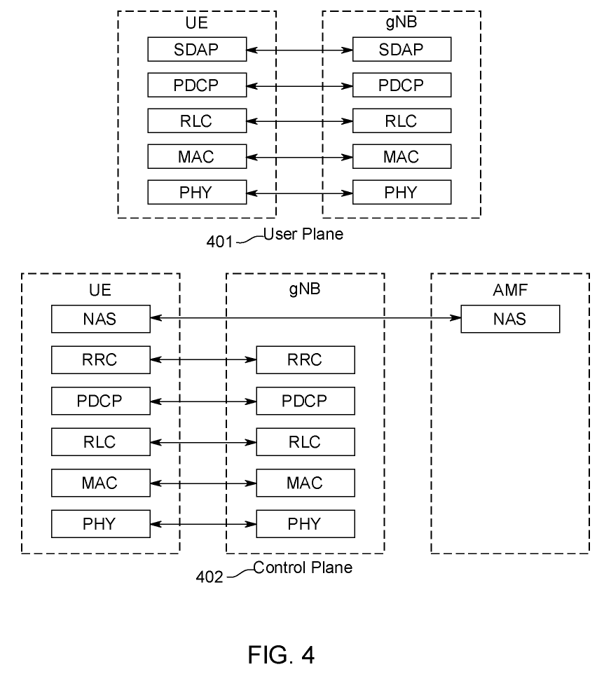

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 1 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

One or more examples described herein may extend 3GPP sharing beyond NR to non‑3GPP access (notably Wi‑Fi) by a MOCN-like model where a shared Wi‑Fi/TNAN advertises multiple PLMNs and a multi-tenant interworking edge (N3IWF/TNGF‑like) simultaneously anchors N2/N3-style connectivity to multiple operator cores, preserving separate subscriber/control domains; and an INS-like model where partner traffic is routed via the host operator’s controlled core and core‑to‑core interconnects, enabling trusted Wi‑Fi, single-step SIM/EAP authentication, predictable latency, and enforceable end‑to‑end QoS. These enable new MSO/MVNO and reciprocal cross‑RAT sharing deployments (e.g., host shares both NR+Wi‑Fi; two operators cross-share their best RATs), yielding broader coverage, seamless multi‑access mobility, resilience, faster rollout, service differentiation, and new bundles. Novelty: explicit multi-core IWF procedures, PLMN signaling in Wi‑Fi, and managed INS transit replacing “internet-to-N3IWF” untrusted assumptions.

In some cases, it may be efficient to have one or more components from a communications network (e.g., such as the one or more components disclosed herein) shared between more than one entity. For example, multiple operators may share a radio access network (RAN) (e.g., for LTE, 5G, 6G, etc.), while each operator may keep (e.g., control) of its own core network (CN) (e.g., for LTE, 5G, 6G, etc.). This may be called Mobile Operator Core Network (MOCN). In this system, the RAN may be shared across participating operators, but this also means that there needs to be a separate direct connection from a shared RAN to each participating operator’s CN. This may not scale as the number of participating operators and/or the number of shared RANs increases.

For example, in LTE, an eNodeB, antennas, transport, and/or spectrum may be shared between operators.

For example, in 5G, gNB (e.g., central unit and/or distributed unit), antennas, transport, and/or spectrum may be shared between operators.

MOCN may enable core networks of multiple operators to share radio access network and spectrum. Each mobile network operator has its own core network managed independently, in a similar manner to the deployments without active sharing. The shared access network may support propagation and recognition of PLMN IDs across multiple operators. The shared access network may have a 1:1 mapping of PLMN to a S1 MME (4G)/N2 AMF (5G) IP address of a core network of a specific operator. This configuration allows UEs with services enabled via multiple operators to co-exist with radio services provided by a single shared access network.

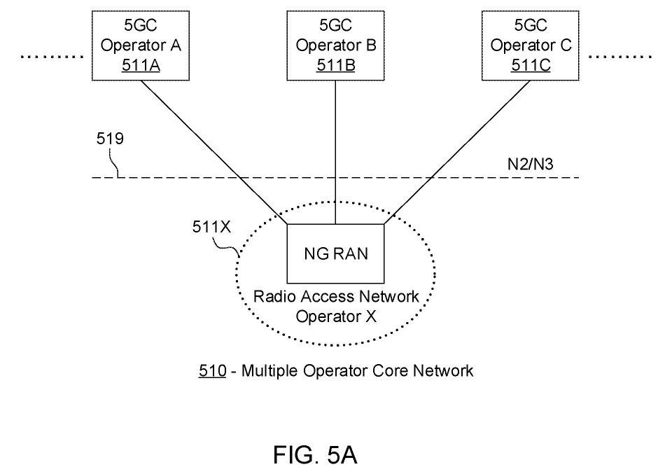

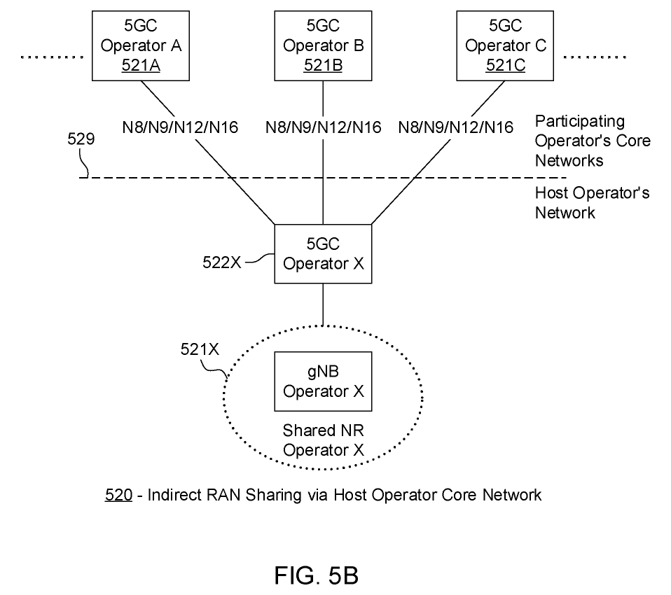

As described herein, FIG. 5A and FIG. 5B are collectively referred to as 5. FIG. 5 illustrates an example of sharing aspects of communications systems applicable to 3GPP access technologies.

FIG. 5A illustrates an example of Mobile Operator Core Network. In this example, there is a 5G Multi-Operator Core Network (MOCN) sharing arrangement in which a single shared NG-RAN is provided/operated by “Radio Access Network Operator X” (511X), while multiple independent mobile network operators each operate their own 5G Core (511A, 511B, and 511C). There is also an operative connection between the shared NG-RAN and each operator’s 5GC via an interface 519. As shown, this NG interface is split into N2 (control plane) and N3 (user plane), labeled “N2/N3” and illustrated by individual lines from the NG-RAN up to each 5GC.

Generally, an N2 (NG-C) carries NGAP signaling between the NG-RAN (gNB) and each operator’s AMF for access and mobility control (e.g., registration, handover control, paging coordination), while N3 (NG-U) carries user-plane traffic (typically GTP-U) between the NG-RAN and the operator-selected UPF that anchors PDU sessions.

In an MOCN configuration, a shared NG-RAN may simultaneously support multiple PLMN identities and associated configuration (e.g., broadcast PLMN IDs and access selection behavior), so that a UE selecting Operator A/B/C is served over the same radio infrastructure but is logically attached to that selected operator’s distinct 5GC; the NG-RAN maintains the necessary per-PLMN/per-operator separation by steering control-plane signaling over N2 toward the correct AMF set and steering user-plane forwarding over N3 toward the correct UPF(s) established for that operator’s sessions.

In an example use case, a neutral-host provider (Operator X) may deploy dense indoor 5G coverage in a large venue (airport, stadium, shopping mall) where it is uneconomical for each MNO to build a full standalone RAN. Operator X may operate a shared NG-RAN, broadcasting support for Operator (e.g., PLMNs) A, B, and C. When a subscriber of Operator B enters the venue, the UE camps on the shared cell and registers to Operator B based on the broadcast PLMN list; the NG-RAN then sends the UE’s access and mobility signaling over N2 to Operator B’s AMF, after which Operator B’s SMF selects Operator B’s UPF to anchor the data session and provides the NG-RAN with user-plane parameters. The NG-RAN forwards the subscriber’s application traffic over N3 toward Operator B’s UPF, while Operator B retains full control of authentication, policy, charging, lawful intercept obligations, slicing exposure, and service continuity within its own 5GC. Meanwhile, subscribers of Operators A and C in the same venue use the same physical radios but are anchored in their respective cores via their own N2/N3 connectivity, allowing all three operators to improve coverage and capacity quickly with shared capex/opex at the RAN layer while preserving competitive differentiation and regulatory separation at the core layer.

In some cases, the sharing aspect of MOCN may be taken a step further, where one operator (e.g., host) owns and operates the RAN and the core network, and one or more other operators (e.g., participating operators external to the host operator’s network) provide service to their subscribers through the host’s CN, rather than connecting the RAN directly to their own CNs. This may be called indirect RAN sharing, also called Indirect Network Sharing (INS), via a host operator’s CN. Such a system may enable network sharing without the need of interfacing the shared RANs to individual participating Operator CNs; also, this allows participating operators who do not have their own RAN infrastructure to minimize CN functions to be hosted.

Generally, in indirect network sharing, a shared RAN broadcasts multiple PLMN IDs—one for the hosting operator and others for participating operators. The serving AMF of the host operator handles these PLMN IDs, enabling UEs from participating operators to select and connect to their respective PLMNs based on existing procedures. The core network functions (such as AMF, SMF, UDM, AUSF) serve UEs based on the PLMN ID of the participating operator or the hosting operator, guided by principles such as home routing. During procedures like PDU Session Establishment, the serving PLMN ID is chosen according to whether functions are interacting across the shared or the hosting network, ensuring correct routing and policy application in a multi-operator, shared infrastructure environment.

FIG. 5B illustrates an example of Indirect Network Sharing. In this example, there is “indirect” NR RAN sharing in which Operator X (521X) is the hosting operator that owns and operates both the shared radio access (e.g., gNB, RAN, etc.) and a hosting 5GC, while Operators A, B, and C ((521A, 521B, and 521C) are participating operators whose subscribers obtain access to the shared RAN via inter-PLMN connectivity to Operator X’s 5GC rather than by terminating NG directly from the shared gNB into each participating operator core (e.g., as in the example of FIG. 5A). Not shown, but in this example it is implied, the gNB may be operatively connected upward to 5GC Operator X over a NG interface (e.g., N2 for NGAP control plane to the AMF in Operator X and N3 for user plane to Operator X UPF). Above 529 is the participating operators’ core networks, and below the hosting operator’s network. In the participating operator’s core networks there may be one or more reference points N8/N12/N16/N9, reflecting a roaming-style inter-PLMN functional split where Operator X acts as the visited/hosting network for access and session anchoring and the participating operator (e.g., A, B, and/or C) provides home-network control-plane and (optionally) user-plane functions.

Generally, reference point N8 is used for the visited AMF (in Operator X) to access subscriber data in the home UDM (in Operator A/B/C), N12 is used for the visited AMF to interact with the home AUSF for authentication, N16 is used between SMFs (visited SMF in Operator X and home SMF in Operator A/B/C) for session management coordination depending on the roaming model, and N9 is used between UPFs in different PLMNs when chaining user-plane (e.g., home-routed traffic or inter-PLMN UPF interconnection).

In example operation, a participating operator’s UE may camp on Operator X’s gNB, is admitted and controlled by Operator X’s AMF/SMF as the hosting network, and Operator X’s core then reaches back to the participating operator’s core over N8/N12/N16 (and optionally N9) so the participating operator retains subscriber ownership, authentication, and—where required—policy/session control and/or user-plane anchoring, while the participating operator has no direct RAN-to-core (NG) termination to the shared gNB in this “host-core” sharing model.

Sharing RAN infrastructure and roaming to a visited network are two distinct concepts in mobile networking. RAN sharing involves multiple operators jointly utilizing the same physical radio access network infrastructure—such as towers, antennas, and sometimes even base station equipment—within a specific geographic area. This allows operators to reduce costs, improve network coverage and capacity, and optimize resource utilization, while each operator retains its own core network and subscriber management. On the other hand, roaming allows a subscriber from one operator to access network services through another operator's network when outside their home network's coverage area. In this scenario, the user's home network manages billing and subscriber services, and the connection typically incurs higher charges due to inter-operator agreements. Unlike RAN sharing, roaming is characterized by temporary access to a foreign network rather than a permanent infrastructure sharing arrangement, and it often involves different regulatory and operational frameworks. Additionally, network sharing is invisible to end users - they connect to their home operator's service running on shared infrastructure without knowing about the arrangement. Roaming is, instead, explicit, with users receiving notifications when switching to a partner network.

In some cases, Multi-Operator Core Network (MOCN) may be applicable for non-3GPP access. Generally, a non-3GPP network operator may have varied deployments – trusted, untrusted, and/or wireline. Implementing MOCN for non-3GPP access may involve extending core-sharing principles established within 3GPP to heterogeneous access technologies (e.g., non-3GPP access) such as Wi-Fi (untrusted or trusted). For example, in NR, MOCN may enable multiple operators to share the same radio access network while maintaining separate subscriber data and core networks, with shared control and radio resources managed by a centralized Radio Resource Management (RRM) system. Depending on the type of non-3GPP access the non-3GPP network operator may need interfacing with different interworking functions across multiple participating operators who would want to share access to the non-3GPP network.

Generally, an Interworking Function (IWF) is a logical function that enables interoperability between one access technology (e.g., NR (5G)) and other networks or protocols by translating, adapting, or mapping information so that otherwise incompatible systems can work together. In some situations, where the 3GPP and non-3GPP access are owned and operated by different operators, the non-3GPP access may be treated as untrusted and the N3IWF is owned by the participating operator rather than the host operator. In such situations, the operators may be reluctant to open up N2/N3 interfacing to their AMF due to trust policies. Accordingly, what is needed are systems and/or procedures for connecting an IWF (N3IWF or TNGF) directly to multiple operator core networks simultaneously. MOCN may enable participating operators to share the non-3GPP access network of the hosting operator with multiple N2/N3 interfacing with the participating operator’s core network.

Generally, reference points Y2, Ta, Y4, and Y5 may define how a trusted or untrusted non-3GPP access network (such as WLAN) connects through an Interworking Function (IWF) to the mobile core: Ta is the user-plane reference between the UE and the IWF, which may carry IP traffic protected by IPsec when the access is untrusted; Y2 is the control-plane reference between the IWF and the core control functions, which may be used to transport mobility management, session control, and authentication signaling; Y4 is the user-plane reference from the IWF to the core user-plane function, which may forward user data after decapsulation and policy enforcement; and Y5 supports interactions with policy, charging, and AAA functions that handles authorization, QoS, and/or billing across 3GPP and non-3GPP accesses.

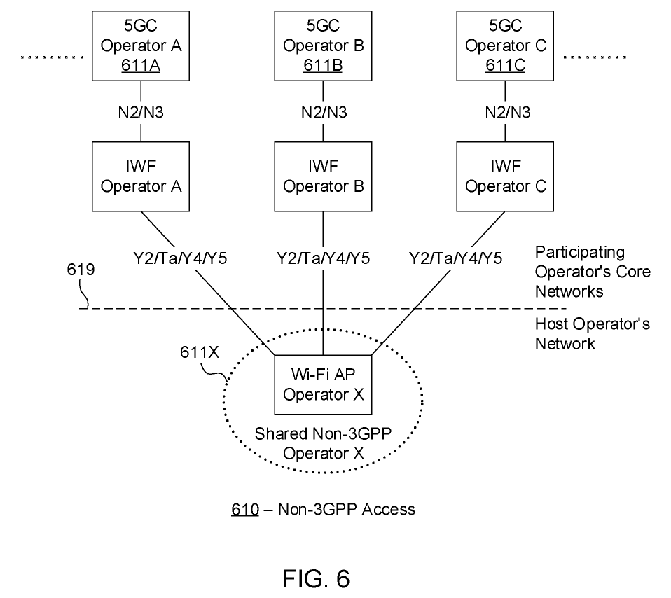

FIG. 6 illustrates an example of MOCN for non-3GPP access. As shown, there may be three participating operators (611A, 611B, 611C), and each operator (e.g. 5GC) may have an NG connection (e.g., N2/N3 as explained herein) to its own IWF. Above 619, each participating operator’s core network has its own 5GC and IWF, and below 619 the host operator’s network may connect to each operator’s IWF via a reference point Y2,Ta,Y4,Y5 (e.g., as explained herein). The host operator’s network (Operator X) may be the shared non-3GPP access 611X, such as a Wi-Fi Access Point (AP) of Operator X. In this example, a subscriber of a specific participating operator may connect to the Wi-Fi AP (e.g., network) of Operator X and may then connect to the subscriber’s participating operator’s core network via an IWF that belongs to the subscriber’s participating operator via the reference point Y2,Ta,Y4,Y5.

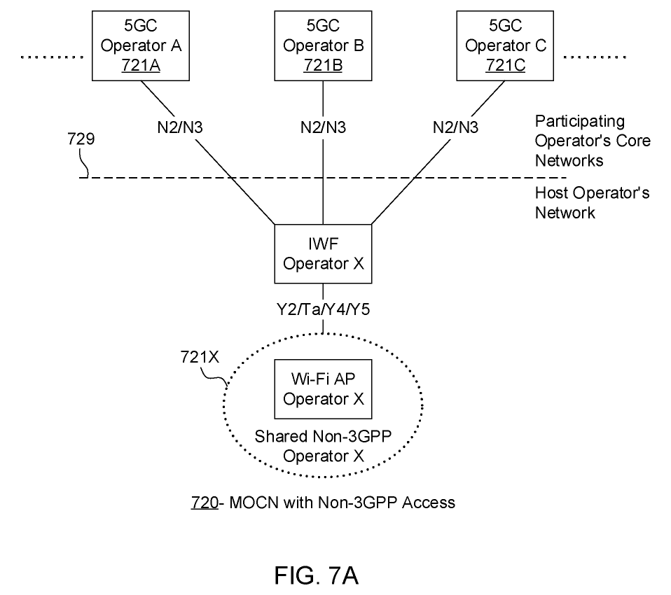

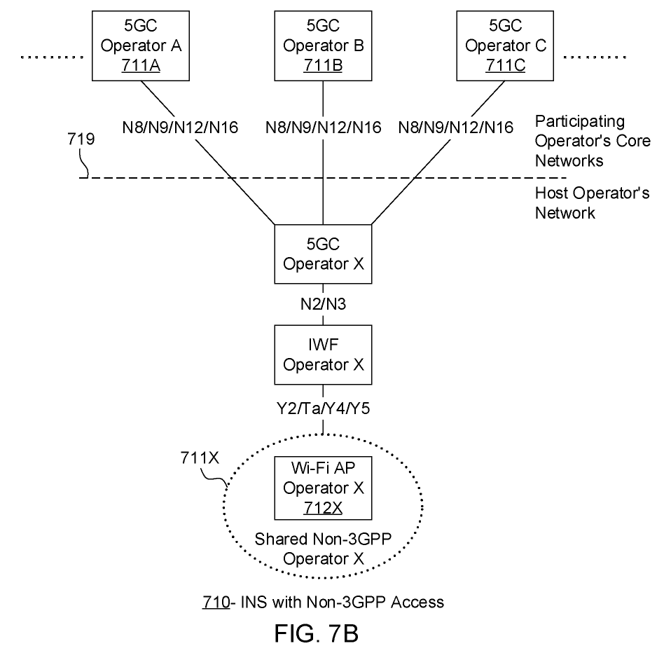

FIG. 7 illustrates an example of MOCN for non-3GPP access with shared interworking. As shown, there may be three participating operators (721A, 721B, 721C), and each operator (e.g. 5GC) may have an NG connection (e.g., N2/N3 as explained herein). However, unlike the example of FIG. 6, here in FIG. 7 each operator may have an NG connection to the host’s IWF, which then has a connection to the non-3GPP access 721X, such as a Wi-Fi AP of Operator X via a reference point Y2,Ta,Y4,Y5 (e.g., as explained herein). Above 729, each participating operator’s core network has its own 5GC, and below 729 the host operator’s network hosts the IWF. In this example, a subscriber of a specific participating operator may connect to the Wi-Fi AP (e.g., network) and IWF of Operator X and may then connect to the subscriber’s participating operator’s core network via NG connection (e.g., N2/N3).

Generally, indirect network sharing (INS) relates to supporting RAN sharing without a direct connection between the shared RAN of the hosting operator and the participating operator’s core network. Such a system may enable communication between the shared RAN and the participating operator’s core network being routed through the hosting RAN operator’s core network. INS addresses a key challenge for the operators with regards to the maintenance of the interconnections (e.g., number of network interfaces) between the shared RAN and participating operators’ core networks, especially in the case of a large number of shared base stations. Although this issue may not exist with deployments of non-3GPP access, there may be other potential challenges.

In 5G, for inter-operator scenario, the untrusted non-3GPP access network connection to a 3GPP core may be via the non-3GPP interworking function (N3IWF). In some instances, regardless of whether the non-3GPP access is owned and operated by the hosting network (managed Wi-Fi) or the non-3GPP access is a public Wi-Fi (unmanaged Wi-Fi), it may be treated as untrusted non-3GPP access by the participating operator. In case of untrusted non-3GPP access, the 3GPP and non-3GPP access registrations may be independent of one another. Once the UE registers with an untrusted non-3GPP access using non-3GPP access credentials, and has internet access, the UE may connect to the N3IWF by formulating an FQDN that resolves to a public IP address, where the traffic flows from the non-3GPP access to the N3IWF over the internet. This may be an unmanaged connection where the operator has no control over how the traffic traverses from the untrusted non-3GPP access to N3IWF which may result in potentially high latency.

One way to resolve this issue may be with using the INS architecture for non-3GPP access sharing similar to the specified INS architecture for 3GPP access (e.g., as discussed herein).

FIG. 7B illustrates an example of INS for non-3GPP access. As shown, there may be three participating operators (711A, 711B, 711C); above 719, each participating operator’s core network has its own 5GC. Each participating operator may have a connection (e.g., N8/N9/N12/N16) to a host operator (e.g., Operator X 711X) 5GC. From there, below 719, the Operator X may control the remaining nodes/connections that lead to any given operator’s UE. Operator X 5GC may have an NG connection to Operator X IWF, which in turn has a Y2,Ta,Y4,Y5 connection to a Wi-Fi AP of Operator X. In this example, a subscriber of a specific participating operator may connect to the Wi-Fi AP (e.g., network), IWF, and 5GC of Operator X and may then connect to the subscriber’s participating operator’s core network via a N8/N9/N12/N16 connection.

In an example, such as that illustrated by FIG. 7B, the non-3GPP access is owned and operated by the hosting operator, the host operator can treat the non-3GPP access as a trusted non-3GPP access network. Trusted non-3GPP access may benefit from direct authenticated access to the Wi-Fi network using the UE’s credentials (e.g., SIM, eSIM, etc.), thereby creating a more streamlined authentication process and reducing latency, unlike untrusted non-3GPP access where the UE has to authenticate twice, once to gain access to the Wi-Fi network and then for the untrusted access to the 5GC via N3IWF. Furthermore, with non-3GPP access network owned and operated by the host operator, the operator can have complete control over how the traffic traverses to participating operator’s core network via the host operator network. This enables end-to-end QoS policies and traffic prioritization that may be difficult to implement across untrusted networks. Additional capabilities enabled through sharing of the hosting operator’s non-3GPP access as trusted to the participating operator may include unified policy management becomes feasible allowing operator policies for data usage, content filtering, and service prioritization to be applied consistently regardless of the access technology, better network optimization because the hosting operator has direct visibility into trusted access networks, and reducing processing overhead and complexity by allowing the traffic of the participating operator’s UE to be carried without additional encryption layers.

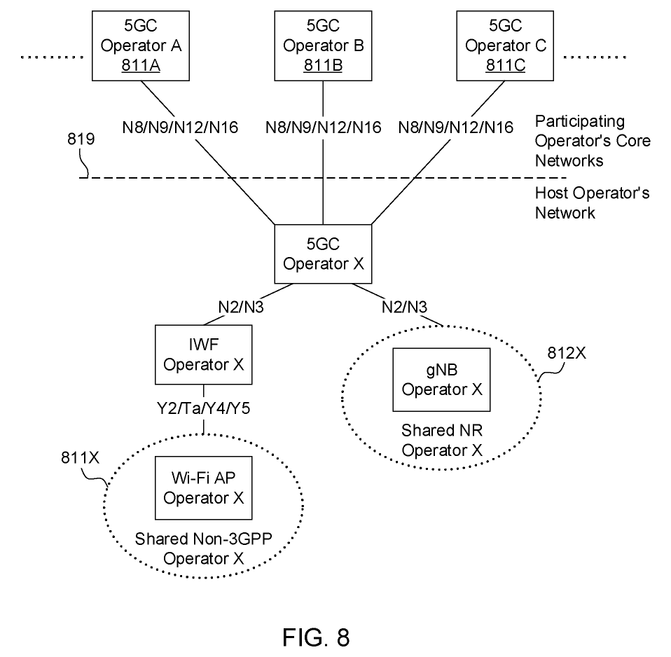

FIG. 8 illustrates an example of INS for non-3GPP access and 3GPP access. As shown, there may be three participating operators (811A, 811B, 811C); above 819, each participating operator’s core network has its own 5GC. Each participating operator may have a connection (e.g., N8/N9/N12/N16) to a host operator (e.g., Operator X) 5GC. From there, below 719, the Operator X may control the remaining nodes/connections that lead to any given operator’s UE, regardless of access technology. Operator X’s 5GC may have an NG connection to the IWF of Operator X, which in turn has a Y2,Ta,Y4,Y5 connection to a Wi-Fi AP of Operator X (811X). Additionally, Operator X’s 5GC may have an NG connection to the gNB of Operator X (812X). In this example, a subscriber of a specific participating operator may connect to the Wi-Fi AP (e.g., network) and IWF of Operator X, or, the subscriber may connect to the gNB of Operator X. In either case, the subscriber would then connect to the subscriber’s participating operator’s core network via a N8/N9/N12/N16 connection through the 5GC of Operator X.

In an example, such as FIG. 8 the host Operator X may share both 3GPP and non-3GPP accesses leveraging the specified INS architecture. The same inter-core interfaces between the host operator’s core network and participating operator’s core network specified as part of the INS architecture for 3GPP access sharing may be utilized for sharing the 3GPP and non-3GPP access of the host operator. Both the 3GPP and non-3GPP access networks owned and operated by Operator X and shared by the participating operators may integrate with the host operator’s core network which interfaces with the participating operators’ core networks. Thus, the participating operators may share the host operators access networks without directly interfacing with them.

Since both 3GPP and non-3GPP access networks belong to and are managed by Operator X, the non-3GPP access network may be treated as trusted access, using a trusted non-3GPP access network (TNAN) and Trusted Network Gateway Function (TNGF) as the interworking function (IWF). In the scenario of trusted access, the TNAN may advertise the PLMNs or SNPNs for which the access network supports trusted connectivity. Thus, the non-3GPP access network selection may be performed using the UE’s 5GS credentials, by first selecting a PLMN/SNPN and then selecting a non-3GPP access network (a TNAN) that supports trusted connectivity to the selected PLMN/SNPN. In this case, the non-3GPP access network selection may be affected by the PLMN/SNPN selection. Another alternative is for the UE to perform non-3GPP access network selection using its 5GS credentials without having to register with the 5GS, by implementing a Non-Seamless WLAN Offload Function (NSWOF) instead of the IWF which would interface with the Wireless Local Access Network (WLAN) of Operator X and the Authentication Server Functions (AUSFs) within the 5GC of participating operator’s network.

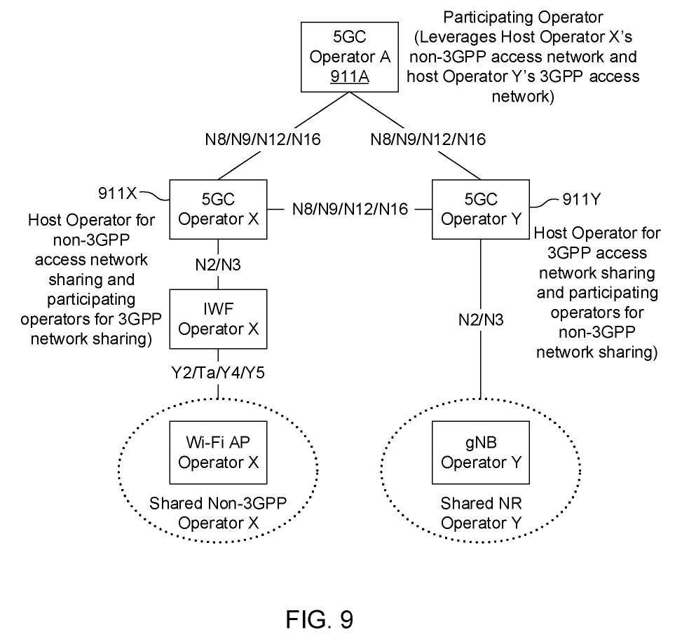

FIG. 9 illustrates an example of INS with different host operators for non-3GPP access and 3GPP access. As shown, there may be a 5GC of Operator A (911A), a 5GC of Operator Y (911Y), and a 5GC of Operator X (911X), each with a connection between each other’s 5GC (e.g., N8/N9/N12/N16, etc.). As shown, Operator X may have non-3GPP access of a Wi-Fi AP, and Operator Y may have a 3GPP access of a gNB. In this example, two operators may share each other’s Radio Access Technology (e.g., the form of access). Operator X, who owns and operates a non-3GPP access network that is shared with Operator Y, and Operator Y who owns and operates a 3GPP access network shared with Operator X. So, for non-3GPP access sharing, Operator X is the hosting operator and Operator Y is the participating operator, while for 3GPP access sharing, Operator Y is the hosting operator and Operator X is the participating operator. And the same inter-core interfaces shared between the Operator X and Operator Y networks may be leveraged for indirect network sharing of different RATs each operator owns. Similarly, Operator A may share the non-3GPP access of Operator X and the 3GPP access of Operator Y. In this example, a subscriber of Operator A may connect to the Wi-Fi AP (e.g., network), IWF, and 5GC of Operator X, or, the subscriber may connect to the gNB and 5GC of Operator Y. In either case, the subscriber would then connect to Operator A’s core network (e.g., 5GC) via a N8/N9/N12/N16 connection through the 5GC of the given operator depending on access (e.g., Operator X or Operator Y).

As discussed herein, applying MOCN and INS to non-3GPP access networks like Wi‑Fi may materially improve the economics and technical capabilities of converged connectivity for non-3GPP access providers (e.g., Wi‑Fi operators), mobile operators, and/or hybrid operators by combining heterogeneous access assets under a coordinated, multi-operator model. This approach may expand the effective coverage footprint by leveraging complementary radio technologies to improve availability, including in hard-to-reach locations, and enable seamless multi-access connectivity so UEs may move between cellular and non-3GPP access points with minimal service disruption. Diversity of access types also increases network resilience by providing alternative connectivity paths during outages or congestion. Operators may preserve differentiation by maintaining control over subscriber management, billing, and/or core-network functions, allowing customized service packages while sharing underlying access infrastructure. The resulting flexibility supports emerging, performance-sensitive applications (e.g., AR/VR and low-latency gaming) through improved bandwidth, QoS, and mobility handling across radio access technologies.

For illustration purposes, and not intending to be limiting, it may be noted that FIGS. 7A, 7B, illustrate how one or more techniques of FIGS. 5A and 5B, respectively, may be applied to non-3GPP access. Further, FIGS. 8 and 9 illustrate how one or more techniques from either FIG. 7A and 7B may be leveraged (e.g., extended) to realize different deployment types.

In one example, based on one or more systems described herein, in a host-access / participant-core scenario (functionally aligned with 3GPP roaming-style inter-PLMN operation), a UE that is provisioned for the participating operator (home PLMN) first camps on the host operator’s 3GPP radio access (the host NG‑RAN/gNB) when coverage is available and the UE is permitted to use the host network (e.g., via roaming or an equivalent commercial sharing arrangement). The UE initiates 5G registration over the air; the host gNB terminates the radio protocols and forwards the UE’s NAS signaling to the host operator’s AMF across the N2 interface (NG‑C). The host AMF then performs subscriber authentication and subscription retrieval against the guest operator’s home core functions, typically invoking the participating operator’s AUSF for 5G‑AKA authentication over N12 and the participating operator’s UDM for subscription data over N8 (in roaming deployments, these inter-PLMN control-plane exchanges are commonly protected via SEPP-to-SEPP connectivity using the N32 interface). Once authenticated and authorized, the host AMF completes registration and, for data service, selects (or interacts with) an SMF to establish a PDU session; depending on the chosen roaming model, the session may be anchored locally in the host network (visited/local breakout) with a host UPF, or coordinated with / anchored by the participating operator using SMF interworking over N16 and user-plane chaining over N9 between a host UPF and a participating operator’s UPF (home routed). Finally, the host gNB establishes the user-plane bearers and forwards user traffic on N3 (NG‑U) toward the selected host UPF, and—if home routing is used—the traffic continues across the inter-PLMN user-plane to the participating operator’s UPF, so the UE obtains service “through” the host’s 3GPP access while key subscriber and service control functions remain tied to the participating operator’s 5GC.

In one example, based on one or more systems described herein, to reach a participating operator’s 5G Core (home PLMN) via a host operator’s non‑3GPP access (for example, Wi‑Fi), the UE first attaches to the host’s WLAN access point and completes link-layer access authentication (typically 802.1X/EAP for enterprise Wi‑Fi, or equivalent access authentication for the non‑3GPP technology). From there, the UE’s 5G signaling is carried into the host operator’s 5G system through an interworking gateway in the host domain: for untrusted non‑3GPP access this is commonly an N3IWF, with the UE establishing an IKEv2/IPsec tunnel to the N3IWF to protect NAS over the N1 path; for trusted non‑3GPP access this role is performed by a trusted gateway (for example, TNGF) where the access network is treated as trusted and the 5G control/user-plane is forwarded on the UE’s behalf. The host interworking function then relays control-plane signaling over N2 to the host AMF, which performs registration handling while reaching back to the participating operator’s 5GC for “home” subscriber functions—typically invoking the participating operator’s AUSF for authentication and the participating operator’s UDM for subscription data (inter-PLMN control-plane exchanges are commonly protected via interconnect security such as SEPP/N32 in roaming-style deployments). Once the UE is authenticated and registered for the participating operator’s PLMN context, session establishment proceeds via an SMF (in the host domain for visited anchoring, or coordinated with the participating operator’s SMF depending on the commercial/technical model), and user-plane forwarding is set up from the host interworking gateway over N3 toward a host UPF and, when home-routed service is required, onward to a participating operator’s UPF via N9. Net result: the UE uses the host’s Wi‑Fi (or other non‑3GPP) access and the host’s interworking gateway as the ingress, while the participating operator’s 5GC provides the home-network subscriber authentication/authorization and, depending on routing choice, also provides session anchoring and service policy enforcement.

In one example, in a MOCN-style non‑3GPP access sharing architecture, the “host” role may be limited to providing the shared non‑3GPP access (e.g., Wi‑Fi APs within a shared TNAN) and an interworking function that may terminate the access-side security and then fan out toward multiple operator cores. After the UE associates to Wi‑Fi and performs access authentication/authorization (e.g., via 802.1X/EAP), the UE may be steered based on the selected/indicated PLMN to the participating operator context, and the non‑3GPP interworking function (e.g., a shared N3IWF/TNGF logically partitioned per PLMN, or distinct per‑PLMN interworking instances behind a shared access) forwards the UE’s 5G control-plane signaling directly to the participating operator’s AMF (N2) and establishes user-plane connectivity toward the participating operator’s UPF (N3). In one instance, there is no “serving” host 5GC acting as a visited core for the UE’s 5G registration and session control; authentication, subscription retrieval (UDM/AUSF), session policy, and anchoring may be handled within the participating operator’s own 5GC for that UE, with the shared non‑3GPP access and interworking layer behaving analogously to a shared RAN in MOCN (e.g., it connects natively and separately to multiple cores rather than using core‑to‑core roaming interfaces).

In one example, in an INS-style non‑3GPP access sharing architecture, the UE may connect to the host operator’s Wi‑Fi/TNAN, terminates non‑3GPP access security toward a host-domain interworking function (e.g., N3IWF for untrusted Wi‑Fi with UE–N3IWF IKEv2/IPsec, or TNGF for trusted access), and the UE’s 5G registration and session establishment may be anchored in the host operator’s 5GC (host AMF/SMF/UPF) as the serving/visited network. The host core may then reach the participating operator’s 5GC over inter‑PLMN/core‑to‑core interfaces for “home” functions—such as to the participating operator’s AUSF/UDM for authentication and subscription (e.g., N12/N8, protected via SEPP/N32 in roaming-style deployments), and, depending on the routing model, to the participating operator’s SMF/UPF for session coordination and/or home-routed user-plane (e.g., N16 and N9). Operationally, an INS system may have (1) the host 5GC remain in the middle of the control-plane path, (2) the UE may not be directly “terminated” into the participating operator’s AMF/UPF from the access/interworking edge, and (3) any participant-core involvement may be realized through governed core‑to‑core interconnect/peering arrangements rather than direct access-to-participant-core attachment.

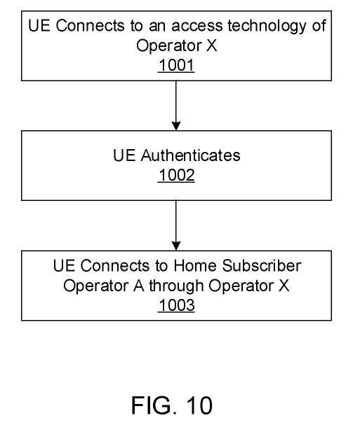

FIG. 10 illustrates an example process/system of a UE connection to a home Operator’s network through a host Operator. According to one or more techniques described herein, at 1001 a UE (e.g., a subscriber of Operator A) may connect using an access technology (e.g., 3GPP and/or non-3GPP) of Operator X. At 1002, the UE may perform authentication. The authentication may be specific to the local access technology. The authentication of the access technology may be forwarded to the UE’s home network, by passing the need for secondary authentication. The authentication may be specific to the UE’s home network, and Operator X may simply act as a forwarding point. At 1003, after authentication is completed, the UE may connect (e.g., send/receive one or more non-authentication messages) to Operator A’s network (e.g., PLMN, 5GC, etc.).

In some examples, a user equipment (UE) sends uplink traffic over Wi-Fi to a Wi-Fi access point (AP) operated by a first operator, and the AP forwards that traffic to an interworking function (IWF) of the first operator. The IWF receives the forwarded traffic over an interconnect such as Y2, Ta, Y4, or Y5, and then forwards the traffic onward toward a 5G core network (5GC) operated by a second operator—effectively allowing the UE’s Wi-Fi access to reach services anchored in a different operator’s core. In certain deployments, the IWF may deliver the traffic directly toward the second operator’s 5GC; in other deployments, the IWF forwards the traffic to a 5GC of the first operator first (for example via N2 and/or N3), and the first operator’s 5GC then routes the traffic to the second operator’s 5GC using inter-core interfaces such as N8, N9, N12, and/or N16.

In other examples, the IWF performs selection and translation functions before forwarding: the IWF determines that the traffic should be associated with the second operator (for example, by evaluating a UE identifier, a realm/domain indicator, roaming information, a network slice indicator, an access-selection policy, or a subscription record available to the first operator). The IWF may encapsulate the traffic into a protocol data unit suitable for delivery toward the 5GC and may map access-side parameters from the Wi-Fi domain (such as a Wi-Fi identifier, QoS marking, traffic class, or bearer indicator) into corresponding core-network parameters used by the first operator’s and/or second operator’s 5GC. The IWF may also generate signaling to establish, modify, or maintain a session corresponding to the UE’s traffic, with control-plane handling logically separated from user-plane forwarding (for example, control-plane signaling via N2 and user-plane forwarding via N3 where applicable). In addition, the IWF may maintain state correlating the UE’s Wi-Fi access context at the AP with the UE’s 5G core context at the second operator’s 5GC, and may update that correlation in response to mobility events, QoS changes, session modifications, or reselection between routing paths (e.g., direct-to-second-5GC versus via the first operator’s 5GC).

In still other examples, the IWF’s role depends on whether the non-3GPP access is treated as untrusted or trusted. For untrusted non-3GPP access, the IWF may operate as an N3IWF that provides interworking between an untrusted access domain and the second operator’s 5GC, including establishing security associations (e.g., IKE) with the UE, terminating an IPsec tunnel carrying the UE’s traffic, applying integrity and/or encryption functions, and optionally performing packet filtering and anti-spoofing checks before forwarding user-plane packets toward the 5GC (e.g., toward a UPF). The N3IWF may also relay non-access stratum (NAS) signaling between the UE and an AMF in the second operator’s 5GC. For trusted non-3GPP access, the IWF may instead operate as a trusted non-3GPP gateway function (TNGF), in which case the system may omit untrusted-access security termination at the IWF, rely more heavily on the trusted access relationship, and enforce admission control based on trust and policy between operators; in some such trusted deployments, the IWF may forward traffic as trusted-access traffic and may use an access-network identity assertion to expedite registration or session establishment in the second operator’s 5GC. In further examples, the IWF is configurable to support both modes—selecting between N3IWF (untrusted) and TNGF (trusted) operation based on an identifier of the AP, roaming configuration, subscription attributes, slice indicators, policy rules, congestion, or service requirements—and then applying the corresponding security and forwarding behaviors, including whether UE security is terminated at the IWF or delegated in whole or part to the Wi-Fi access domain.

As described herein, a higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein. In one example, a base station may be distributed (e.g., different units that address or include different functions/layers/protocols/hardware/etc.; a first unit, second unit, etc.).

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something "does happen" or "can happen". In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a, UE, terminal, base station, RNC, or any host computer.

As disclosed herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’ may imply ‘A and/or B’.

As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

As described herein, "at least one of" may be interchangeable with "one or more of".

As described herein, reference of a configuration may mean that at some point a UE may receive a message that includes configuration information. In one instance, the UE may provide feedback after having received it. In one instance, the UE may request the message. In one instance, the message may be unrequested.

Embodiments and examples described herein are provided for illustration and may be explained in the context of a particular wireless access technology, standard, protocol, or generation (e.g., 5G/NR). Unless otherwise indicated, such description is not intended to be limiting to that specific technology. Rather, the disclosed techniques, apparatuses, systems, and methods are intended to be applicable, as appropriate, to any wireless communication technology, including present and future cellular generations (e.g., 2G, 3G, 4G/LTE, 5G/NR, 6G, 7G and beyond) and non-cellular wireless technologies (e.g., Wi-Fi/IEEE 802.11, Bluetooth, Zigbee, UWB, satellite, and other wireless access technologies), and to any combination thereof. Accordingly, references to particular air interfaces, bands, numerologies, frame structures, network architectures, nodes, or terminology associated with a specific standard are examples only, and are intended to encompass analogous or corresponding features in other wireless systems to the extent consistent with the principles disclosed herein.

What is claimed is:

1. A system, the system comprising:
a Wi-Fi access point (AP) of a first operator, wherein the Wi-Fi AP of the first operator is configured to receive a transmission from a user equipment (UE) and forward it to an interworking function (IWF) of the first operator; and
the IWF of the first operator operatively connected to the Wi-Fi AP of the first operator, wherein the IWF of the first operator is configured to receive the forwarded transmission from the Wi-Fi AP and forward the forwarded transmission to a 5G core network (5GC) of a second operator.

2. The system of claim 1, further comprising a 5GC of the first operator operatively connected to the IWF and the 5GC of the second operator, wherein the IWF forwards the forwarded transmission to the 5GC of the second operator through a 5GC of the first operator, wherein the 5GC of the first operator routes the forwarded transmission to the 5GC of the second operator.

3. The system of claim 1, wherein the IWF of the first operator is connected to the Wi-Fi AP of the first operator via at least one of an Y2, Ta, Y4, or Y5 connection.

4. The system of claim 2, wherein the IWF is connected to the 5GC of the first operator through an N2 or N3 connection.

5. The system of claim 2, wherein the 5GC of the second operator is connected to the 5GC of the first operator via at least one of an N8, N9, N12, N16 connection.

6. A method performed by an interworking function (IWF) of a first operator, the method comprising:
receiving, by the IWF from a Wi-Fi access point (AP) of the first operator, a forwarded transmission that originated from a user equipment (UE); and
forwarding, by the IWF, the forwarded transmission toward a 5G core network (5GC) of a second operator.

7. The method of claim 6, wherein forwarding the forwarded transmission toward the 5GC of the second operator comprises forwarding the forwarded transmission to a 5GC of the first operator and causing the 5GC of the first operator to route the forwarded transmission to the 5GC of the second operator.

8-38. 3. The method of claim 6, wherein receiving the forwarded transmission from the Wi-Fi AP comprises receiving the forwarded transmission via a Y2 interface, a Ta interface, a Y4 interface, or a Y5 interface.

9. The method of claim 7, wherein forwarding the forwarded transmission to the 5GC of the first operator comprises forwarding via an N2 interface or an N3 interface.

10. The method of claim 7, wherein the 5GC of the first operator is communicatively coupled to the 5GC of the second operator via an N8 interface, an N9 interface, an N12 interface, or an N16 interface, and wherein routing the forwarded transmission to the 5GC of the second operator uses at least one of the N8, N9, N12, or N16 interfaces.

11. The method of claim 10, further comprising determining, by the IWF, that the forwarded transmission is associated with a subscriber, session, or service of the second operator, and wherein forwarding the forwarded transmission toward the 5GC of the second operator is performed responsive to the determining.

12. The method of claim 10, wherein determining that the forwarded transmission is associated with the second operator comprises evaluating at least one of: an identifier of the UE, roaming information, a network slice indicator, or an access selection policy.

13. The method of claim 6, further comprising encapsulating, by the IWF, at least a portion of the forwarded transmission for delivery toward the 5GC of the second operator.

14. The method of claim 6, wherein the IWF comprises an N3IWF that provides interworking between an untrusted non-3GPP access network and the 5GC of the second operator.

15. The method of claim 14, further comprising establishing, by the N3IWF, a security association with the UE and terminating, by the N3IWF, an IPsec tunnel carrying the forwarded transmission prior to forwarding the forwarded transmission toward the 5GC of the second operator.

16. The method of claim 15, further comprising providing, by the N3IWF, non-access stratum (NAS) signaling between the UE and an access and mobility management function (AMF) of the 5GC of the second operator.

17. The method of claim 6, wherein the IWF comprises a trusted non-3GPP gateway function (TNGF) that provides interworking between a trusted non-3GPP access network and the 5GC of the second operator.

18. The method of claim 17, further comprising enforcing, by the TNGF, access admission control for the UE based on a trust relationship between the first operator and the second operator.

19. The method of claim 6, wherein the IWF is selectively operable in (i) an untrusted non-3GPP access mode as an N3IWF and (ii) a trusted non-3GPP access mode as a TNGF.

20. The method of claim 19, further comprising selecting, by the IWF, the untrusted non-3GPP access mode or the trusted non-3GPP access mode based on at least one of an identifier of the Wi-Fi AP, roaming configuration data, a UE subscription attribute, or a policy rule.
